(19) United States
(12) Patent Application Publication
(10) Pub. No.: US 2011/0270704 A1
(43) Pub. Date: Nov. 3, 2011

(54) RANDOM STARTING PRICE ON-LINE AUCTION

(75) Inventor: Yair SHEMESH, Herzliya Pituach (IL)

(73) Assignee: Olsale.Com Ltd., Herzelia (IL)

(21) Appl. No.: 12/769,700

(22) Filed: Apr. 29, 2010

(51) Int. Cl. G06Q 30/00

(52) U.S. Cl. 705/26.8

(57) ABSTRACT

A method and system of conducting an on-line auction of specific products of a product type so that winning bid amounts among the specific products will vary, a wide range of types of buyers will bid and the quantity offered is affected by the number of bidders. The system fixes a set time frame in which all bidding for all specific products of the product type is to occur. For a specific product of the product type a number of bids is fixed sufficient to trigger an end to bidding and offering an additional specific product of the product type. For each specific product a number is randomly selected and used to fix the starting price of the specific product. Bidders are advised the starting price for the specific product, the fixed number of bids for each specific product offered and the set time frame.

### FIELD AND BACKGROUND OF THE INVENTION

The present invention relates to apparatuses and methods for online auctions, and, more particularly to such auctions having random starting prices for different specific products.

Auction owners want to increase participation in auction and more particularly want to increase the amount of bidding in auctions. For example, some buyers may have a strategy of waiting to make sure a very low price is likely to be the winning bid. Other buyers with the potential to bid may be more anxious to buy or may have a different buying strategy. These other buyers may not wait for a very low price. Alternatively, the other buyers may wait just enough to confirm that the price is not very high. The starting price of an item is set by the auction, as are the bid increments. Thus, the auction house may want to set the starting price and bidding increments in a manner that maximizes participation in the auction.

Attempts have been made to improve the auction process. For example, U.S. Pat. No. 6,847,939 to Shemesh discloses an online auction in which the quantity of products offered is determined by the number of bids placed for the product.

There is a compelling need to have a method or system for operating an auction that will increase participation and bidding from participants in the auction and will draw bids from a wide range of buyers.

### SUMMARY OF THE PRESENT INVENTION

One aspect of the present invention is a method for conducting an on-line auction of a variable quantity of specific products of a product type offered for auction, the method comprising fixing a set time frame in which all bidding for all specific products of the product type is to occur; for a specific product of the product type fixing a number of bids for the first specific product sufficient to trigger (i) an end to bidding for the specific product and (ii) an offering for auction of an additional specific product of the product type; providing, via a communications network, information pertaining to the first specific product auctioned, the information including (i) a starting price for the first specific product and an acceptable bid amount, the starting price selected by a random number selection process, (ii) the set time frame and (iii) the fixed number of bids; receiving via an electronic communication medium competing bids from a plurality of bidders for the specific products, each of the bids having a bid value which exceeds values of all previously received bids; automatically varying the quantity of specific products of the product type offered for auction by ending bidding on a specific product when the fixed number of bids has been reached within the set time frame and offering an additional specific product for auction; and declaring a number of the competing bids having highest bid values as winning bids, the number of competing bids corresponding to the quantity of specific products of the product type auctioned, each of the winning bids enabling purchase of the specific product at the corresponding bid value.

A further aspect of the present invention is directed to a method of conducting an on-line auction of specific products of a product type in a manner that makes it likely that the winning bid amounts among the specific products will vary and that a wide range of types of buyers will bid, the method comprising fixing a set time frame in which all bidding for all specific products of the product type is to occur; for a specific product of the product type fixing a number of bids for the first specific product sufficient to trigger (i) an end to bidding for the specific product and (ii) offering for auction of an additional specific product of the product type; for each specific product of the product type, selecting a number randomly and using that number to fix the starting price of the specific product; notifying potential bidders via a communications network of the starting price for the specific product, the fixed number of bids for each specific product offered and the set time frame; receiving via an electronic communication medium competing bids from a plurality of bidders for the specific products, each of the bids having a bid value which exceeds values of all previously received bids; automatically varying the quantity of specific products of the product type offered for auction by ending bidding on a specific product when the fixed number of bids has been reached within the set time frame and offering an additional specific product for auction; and declaring a number of the competing bids having highest bid values as winning bids, the number of competing bids corresponding to the quantity of specific products of the product type auctioned, each of the winning bids enabling purchase of the specific product at the corresponding bid value.

A still further aspect of the present invention is a system for conducting on-line auctions of products pitched to draw bids from a wide range of buyers of the products, comprising a database server system for receiving and storing competing bids for specific products of a product type being auctioned; user clients receiving information from the database server system concerning the specific products auctioned and sending bids to the database server system; and an executable program stored in the database server system to implement the following functions: (i) fixing a set time frame in which all bidding for all specific products of the product type is to occur; (ii) for a specific product of the product type fixing a number of bids for the first specific product sufficient to trigger an end to bidding for the specific product and an offering for auction of an additional specific product of the product type; (iii) for each specific product of the product type, selecting a number randomly and using that number to fix the starting price of the specific product; (iv) receiving via an electronic communication medium competing bids from a plurality of bidders for the specific products, each of the bids having a bid value which exceeds values of all previously received bids; (v) automatically varying the quantity of specific products of the product type offered for auction by ending bidding on a specific product when the fixed number of bids has been reached within the set time frame and offering an additional specific product for auction; and (vi) declaring a number of the competing bids having highest bid values as winning bids, the number of competing bids corresponding to the quantity of specific products of the product type auctioned, each of the winning bids enabling purchase of the specific product at the corresponding bid value.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a display of information seen by online auction participants in an auction in accordance with one embodiment of the present invention;

FIG. 2 is a flow chart showing a method in accordance with one embodiment of the present invention;

FIG. 3 is a flow chart showing a method in accordance with one embodiment of the present invention;

FIG. 4 is a flow chart showing a further method in accordance with one embodiment of the present invention; and

FIG. 5 is a box diagram of a system in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides an online auction for particular items within a product type or group of such items. The starting price for each particular item in the product type may be randomly generated or may be obtained from a randomly selected number generated by a computer program or physical device for generating such randomly selected numbers. A set time frame for bidding on a group of specific products, for example five refrigerators, may be fixed constituting a relatively short bidding session. Each specific product in the group of products may have its starting price for the auction selected independently and randomly. A fixed number of bids may also be set for each specific product sufficient to trigger an end to bidding on that specific product and the offering of another specific product (of the same product type) for bidding. The randomly selected starting price for each specific product, the time remaining in the set time frame and the remaining number of bids needed to reach the fixed number of bids may be displayed on an online display to bidders in real time. The quantity of specific products offered for auction is therefore responsively affected by the number of bids placed for the specific items.

In contrast to prior art auctions, in which multiple items or products or a specific product type may be offered together as a group so that each specific product is in effect offered at the same price, the auction of the present invention may offer multiple specific products of a product type at different prices. In further contrast to the prior art in which the bidders are told in advance that a certain number of, for example refrigerators, are being offered at the auction, the auction of the present invention may be arranged so that the quantity of items offered of a product type may be unknown by everyone including the auctioneer in advance and may be later determined by the conduct of the bidders. In contrast to prior art auctions, in which the auctioneer may select a starting price pitched to appeal to one type of bidder, i.e. either bidders “desperate” to buy a product or “skeptical” buyers in no hurry to buy the product, but may not be pitched to draw bids to both types of buyers, the methods of the present invention may allow an auctioneer to select a price pitched to appeal to bidders from a wide range of buying types including “desperate” buyers as well as “skeptical” buyers. In further contrast to prior art auctions, in which the starting price of an item is set by the auctioneer, the starting price of auctions of the present invention may be selected at random or fixed based on randomly selected numbers. In further contrast to prior art auction methods and systems, in which the starting price of one item of a group of items of one product type are the same or are related numerically, for example by a formula, in the method of the present invention the starting price for each item or specific product of the group of items of one product type may be unrelated to the starting price of the next such particular item of the same product type. In still further contrast to prior art auctions, in which the quantity of products may vary with the number of bidders but the winning price of each specific product may be the same within a product type, the method of the present invention may vary the quantity of items offered based on the number of bids placed for the specific product or item of this product type while at the same time making it highly likely that the winning prices for each particular item sold vary significantly.

The principles and operation of a method and system for an online auction having a randomly selected starting price according to the present invention may be better understood with reference to the drawings and the accompanying description.

The term “product” when used in relation to products being bid on shall include both goods and services. A “specific product” of a “product type” refers to specific items offered. For example, if the auctioneer is offering five pianos, “pianos” is the “product type” and each individual piano of the five being offered is a “specific product” of that product type. The phrase “about to expire” when used in connection with the set time frame refers to a pre-set number of seconds or minutes or time, for example two minutes, before the previously set expiration time of the set time frame.

The auction of the present invention may include a reserved bid, which represents a minimum amount that a highest winning bid must reach in order for the system 10 of the present invention to permit the winning bid to be eligible to purchase the product offered at auction.

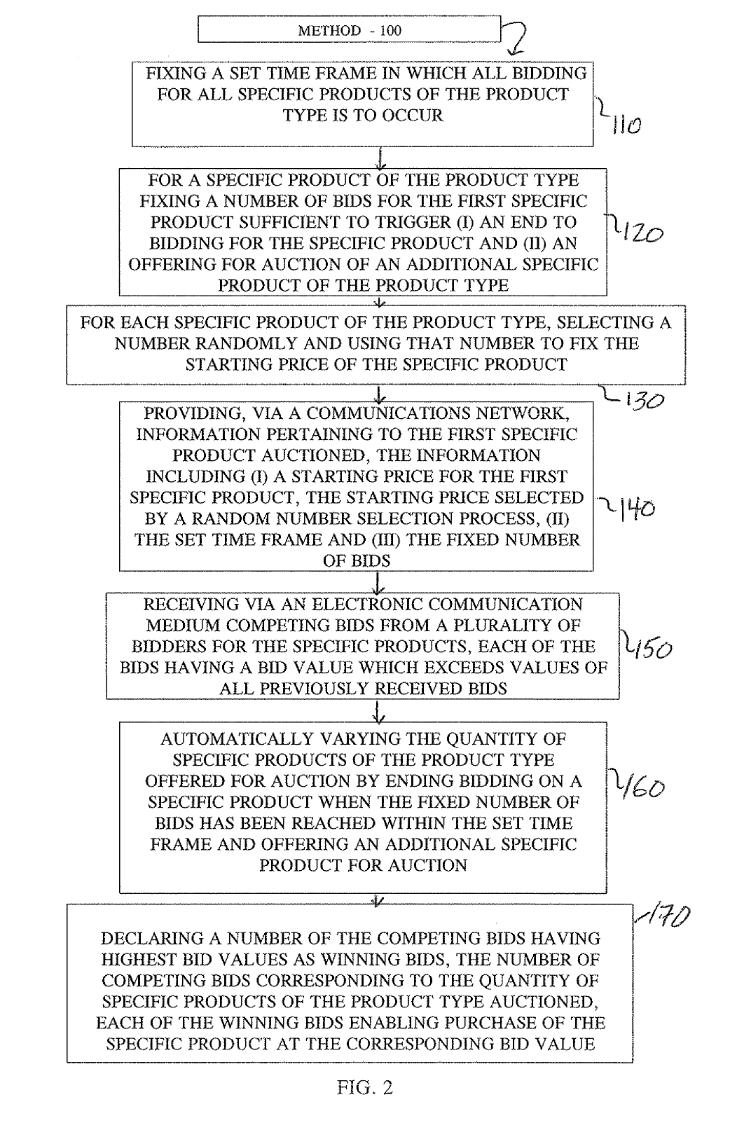

An auction conducted in accordance with the present invention may be characterized as a method 100 having several steps. As shown in FIG. 2, method 100 may involve conducting an on-line auction of specific products of a product type in a manner that makes it likely that the winning bid amounts among the specific products will vary and that a wide range of types of buyers will bid. Method 100 may include a step 110 of fixing a set time frame in which all bidding for all specific products of the product type is to occur. The set time frame may be set by the auction house based on the maximum number of specific products available to be offered as well as the expectation of interest among the buying public.

Typically, the set time frame may be shorter than other online auctions and may vary from ten minutes to sixty minutes or ninety minutes or one hundred and twenty minutes. Purely by way of illustration, the auction of the present invention may fix a set time frame for the sale of five refrigerators at fifteen or thirty minutes. In one variation, the set time frame may be extended by a set amount of time whenever a new bid is placed for the specific product being offered at a time when the set time frame is about to expire. For example, if fifteen minutes has been set as the set time frame in which to finish the bidding for all five refrigerators, once two minutes remain from the fifteen minutes, the set time frame is deemed “about to expire” and whenever a new bid is placed the set time frame is extended by a set amount, for example thirty seconds or one or two minutes.

Method 100 may include a further step 120 of, for a specific product of the product type, fixing the number of bids for the first specific product sufficient to trigger (i) an end to bidding for the specific product and (ii) an offering for auction of an additional specific product of the product type. For example, the product type may be “refrigerators”. The auction may decide that after seventeen bids have been placed for a particular refrigerator, which is the first refrigerator among the group of refrigerators being auctioned, a second refrigerator from the group of refrigerators will be offered. In this case, all bidding for the first refrigerator will be terminated at the highest bid up to that time will constitute the winning bid. This is provided that the set time frame has not expired. The fixed number of bids, i.e. 17, may be applied again to the second refrigerator. If seventeen bids are placed for the second refrigerator and the set time frame has still not elapsed, a third refrigerator will be offered, and so on for all five refrigerators. In an alternative embodiment, the fixed number of bids may vary with each specific product and may be set in advance of the bidding. In a further alternative, the fixed number of bids may be set by the auction to be fixed in a range having a lower limit, for example ten, and an upper limit, for example twenty, and a random number selection process may be used to determine the exact fixed number of bids. The random number selection process may be operated using any of the methods outlined for the selection of the starting price.

Method 100 may include an additional step 130 where for each specific product of the product type, a number is selected randomly and used to fix the starting price of the specific product. Any of various known methods for generating random numbers may be used. These may include computational random number generators that use computer programs and physical random number generators that use physical devices which use the randomness inherent in natural phenomena such as atmospheric noise. These may also include a pseudorandom number generator since the degree of randomness needed in the methods of the present invention may not necessarily have to be pristine and perfect.

The random numbers may be used as the starting price in the auctioning of a specific product. The starting price may also be fixed as a simple function of the randomly generated numbers, for example the starting price may be set at a defined function f of a variable “x”, where “x” is the randomly generated number. In one non-limiting example, the starting price may be set as double or five times or ten times the random number generated. This may allow the starting prices to be round figures.

In a further step 140 of method 100, potential bidders may be notified via a communications network of the starting price for the specific product, the fixed number of bids for each specific product offered and the set time frame, and may be able to view a display, as time elapses, of the time remaining in the set time frame. Method 100 may also include notifying potential bidders how many specific products of the product type are available to be offered at auction given enough bids being placed. In other embodiments, potential bidders are specifically not advised of this information and do not know the number of refrigerators in the group that can be offered if enough bidders place bids.

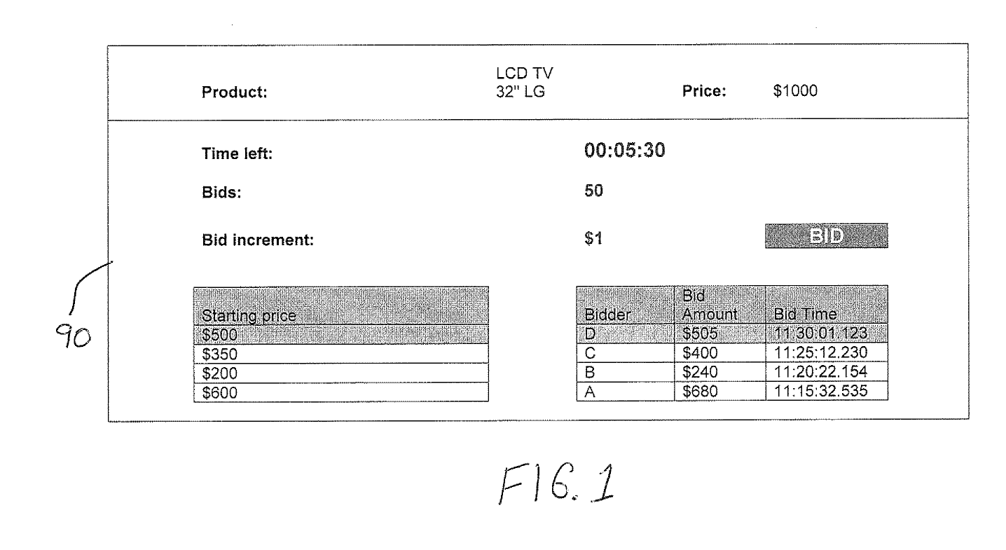

For example, FIG. 1 is an example of a display 90 of information seen by online auction participants in an auction in accordance with an embodiment of the present invention. In the display of FIG. 1, auction participants see the time left from the set time frame under the heading “Time left” as well as the number of bids that for the specific product under the heading “Bids”. In one embodiment, the number of bids on display 90 may be the number of bids remaining to reach the fixed number of bids. For example, the number of bids in the “Bids” section of display 90 may start at the fixed number of bids and be reduced by an integer each time a new bid is placed for that specific product. Display 90 may be updateable in real time as new bids are placed. Users may be able to view and interact with the auction process in real time.

As seen in FIG. 1, display 90 may also include the acceptable bid increment for the currently auctioned specific product, each starting price and each winning bid price for each already completed specific product of the product type currently auctioned, the identity of the winning bidder (not necessarily a real name but may instead be a user name or email address selected by the bidder for participation in the auction) and the time of receipt by system 10 of that winner bidder's price. This allows system 10 to highlight the randomly selected starting price for each specific item. Consequently, additional bidders may participate upon visualizing other possible starting prices for the specific item. Furthermore, by displaying the winning bids, system 10 may also highlight the variability in the winning bids. This variability may be induced by the variability in the starting prices of the various specific products which have been randomly selected since the starting price influences the magnitude of the final winning bid. It may be appreciated that the auction system 10 may thereby induce participation and bidding by a wide range of buyers including those cautious buyers who wait for extremely low prices as well as desperate buyers who jump in right away. In other embodiments, users do not see previous winning bids.

As seen in FIG. 2, method 100 may further comprise a step 150 of receiving via an electronic communication medium competing bids from a plurality of bidders for the specific products, each of the bids having a bid value which exceeds values of all previously received bids. Under a further step 160 of method 100, the system 10 or suction may automatically vary the quantity of specific products of the product type offered for auction by ending bidding on a specific product when the fixed number of bids has been reached within the set time frame and offering an additional specific product for auction.

As shown in FIG. 2, method 100 may also include a step 170 of declaring a number of the competing bids having highest bid values as winning bids, the number of competing bids corresponding to the quantity of specific products of the product type auctioned, each of the winning bids enabling purchase of the specific product at the corresponding bid value.

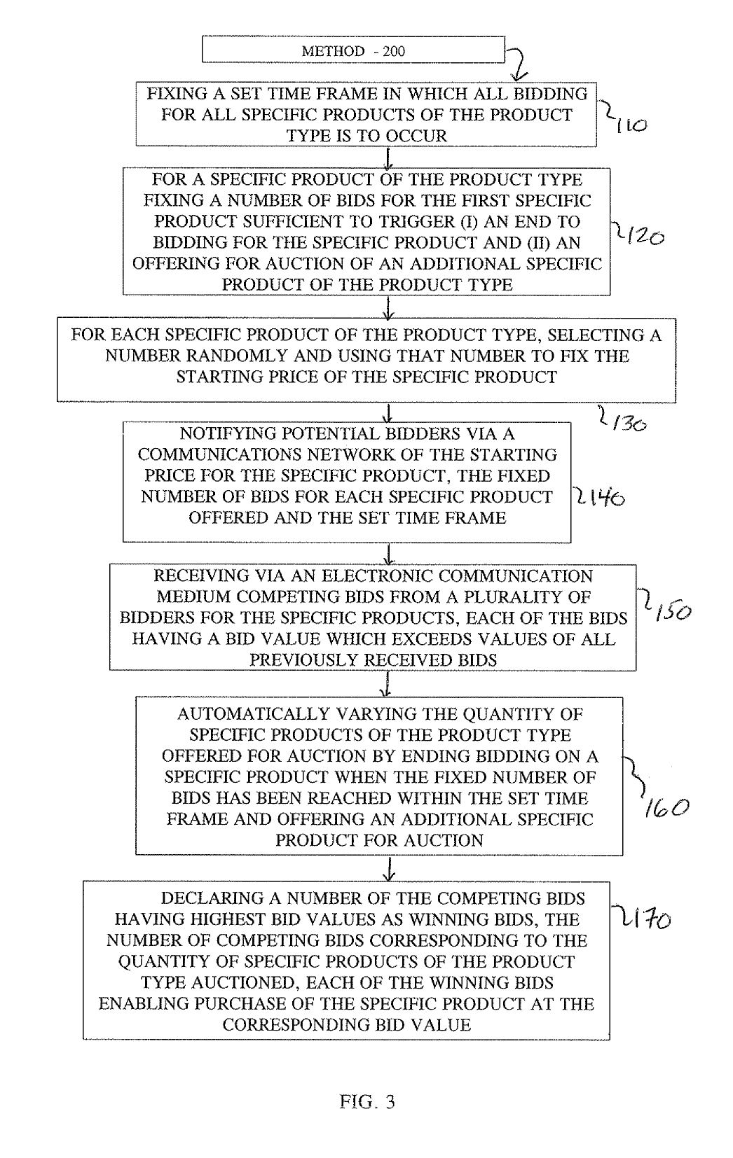

As seen from FIG. 3, the present invention may also be characterized as a method 200 for conducting an on-line auction of a variable quantity of specific products of a product type offered for auction. It will be appreciated that many of the steps of method 200 may be similar to the steps of method 100. For example, method 200 may include a step 210 of fixing a set time frame in which all bidding for all specific products of the product type is to occur. For each specific product of the product type method 200 may include a further step 220 of setting a fixed number of bids for the first specific product sufficient to trigger (i) an end to bidding for the specific product and (ii) an offering for auction of an additional specific product of the product type.

Method 200 also involves a step 230 of providing, via a communications network, information pertaining to the first specific product auctioned, the information including (i) a starting price for the first specific product and an acceptable bid amount, the starting price selected by a random number selection process, (ii) the set time frame and (iii) the fixed number of bids. In a further step 240, competing bids may be received via an electronic communication medium from a plurality of bidders for the specific products, each of the bids having a bid value which exceeds values of all previously received bids.

In a further step 250 shown in FIG. 3, method 200 may automatically vary the quantity of specific products of the product type offered for auction by ending bidding on a specific product when the fixed number of bids has been reached within the set time frame and offer an additional specific product for auction. Method 200 may include a step 260 of declaring a number of the competing bids having highest bid values as winning bids, the number of competing bids corresponding to the quantity of specific products of the product type auctioned, each of the winning bids enabling purchase of the specific product at the corresponding bid value.

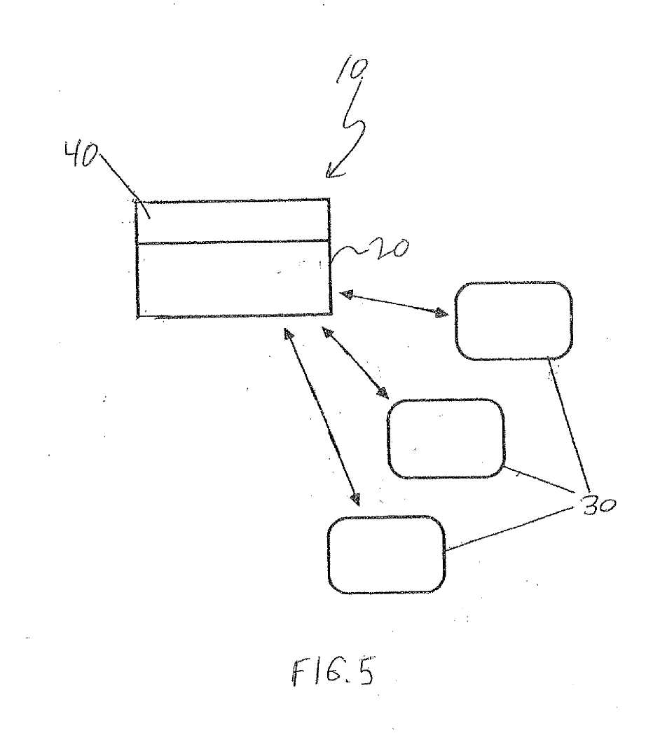

As shown in FIG. 5, the present invention may be described as a system 10 for conducting on-line auctions of products pitched to appeal to a wide range of buyers of the products. System 10 may include a database server system 20 for receiving and storing competing bids for specific products of a product type being auctioned. Database server system 20 may also provide, on demand, information pertaining to a plurality of products to be auctioned. Database server system 12 may be configured such that the number of bids and/or the amount of each bid received determines a quantity of the specific product of a product type currently auctioned. The number of refrigerators in a group of refrigerators currently being auctioned may increase with an increase in the number of bids placed for particular refrigerators. Database server system 20 may also set a maximum auctionable quantity of a product type based on the type of product auctioned and an estimated value of the product. Database server system 20 may include a processing unit which serves to process the information received such that some of the information provided is constantly updated. Incoming bids may at times be received simultaneously. If many bids are received simultaneously, the processing unit of database server system 20 may be programmed to prioritize the bids by their time of receipt and may be able to distinguish between the time received by up to a microsecond.

System 10 may also include user clients 30 (which may be computers operated by users who place bids) for receiving information from the database server system concerning the specific products auctioned and sending bids to the database server system and an executable program 40 stored in the database server system 20 to implement certain functions. User clients 30 receive information from database server system 20 and relay user provided information to database server system 20. The information received by clients 30 may include information pertaining to products stored in server system 20, such as, for example, product description, auction times for each product, initial quantity of the product offered when auctioned, suggested retail price and the like. In addition, information received by client 30 may include information specific to each product currently auctioned. Such information may include the acceptable bid amount which can depend for example, on a current highest bid amount, and a reserved bid amount, which may be the amount that must be surpassed by a bidder in order for that bidder to be eligible to purchase the product auctioned. In addition this information may also include time remaining to bid, minimal amount of next acceptable bid, quantity of the product offered, and the like. It will be appreciated that information pertaining to a product auctioned may be received by user clients 30 in real time at the time the auction is conducted. Thus, a user operating client 30 can decide if to bid or not according to, for example, the current highest bid amount information, time remaining to bid information, and quantity of product information. It will be appreciated that when a bid placed by a user using client 30 is accepted by server system 20 the information provided from server system 20 to a user on a product auctioned may be immediately updated. Clients 30 may also provide user specific information such as contact and billing information.

The functions implemented by program 40 may include many of the steps of methods 100 or 200. In one example, a computer program 40 may (i) fix a set time frame in which all bidding for all specific products of the product type is to occur; (ii) for a specific product of the product type fix a number of bids for the first specific product sufficient to trigger an end to bidding for the specific product and an offering for auction of an additional specific product of the product type; (iii) for each specific product of the product type, select a number randomly and using that number to fix the starting price of the specific product; (iv) receive via an electronic communication medium competing bids from a plurality of bidders for the specific products, each of the bids having a bid value which exceeds values of all previously received bids; (v) automatically vary the quantity of specific products of the product type offered for auction by ending bidding on a specific product when the fixed number of bids has been reached within the set time frame and offer an additional specific product for auction; and (vi) declare a number of the competing bids having highest bid values as winning bids, the number of competing bids corresponding to the quantity of specific products of the product type auctioned, each of the winning bids enabling purchase of the specific product at the corresponding bid value.

System 10 may be used to conduct an auction as follows. Once an auction for a specific product of a specified quantity commences, users are allowed to place bids on the specific product. Users placing bids on this specific product may be listed by server system 20, which list may be viewable by registered users participating or wishing to participate in the bidding process. Such a list may include a portion or all of the bid accepted displayed, for example, in a table format or any other format, or alternatively, only the highest current bid is displayed. A registered use using, for example, a web browser program can then place a bid by, for example, selecting, for example, a “place bid” button provided on a web page, which when selected, places a bid for that user. A newly placed bid is higher than a current highest bid by an amount that may be predetermined by system 10.

Following acceptance of the bid, the list may be automatically updated, indicating a new highest bid. Database server system 20 may track the number of bids that have been placed for a specific product so as to change the quantity of the product auctioned, accordingly. Users who have placed bids lower than the highest bid of the auction but higher than a reserved bid amount for that product may also have a chance of winning by bidding a next specific product, which may enter the bidding process at a much lower number, in accordance with the random number selection process. At the end of a bidding session, winning bids may be determined and the users which have placed the winning bids are notified, by, for example, an electronic mail message. Thereafter, these users are billed either directly, by using the billing information included in each user's personal profile information, or indirectly, by having each of the users provide billing information. Optionally, a user may be charged a set amount for each bid placed by that user.

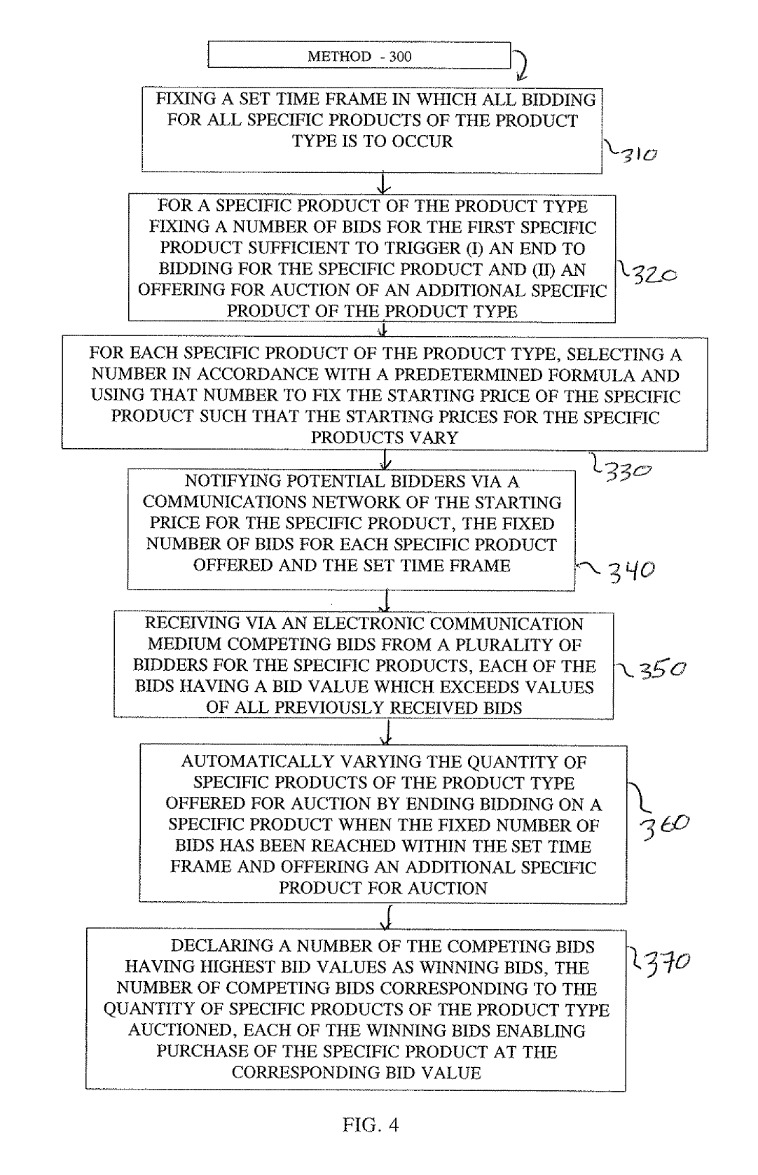

As seen in FIG. 4, the present invention may also be characterized as a method 300 of conducting an on-line auction having a step 310 of fixing a set time frame in which all bidding for all specific products of the product type is to occur and a step 320 of, for a specific product of the product type fixing a number of bids for the first specific product sufficient to trigger (i) an end to bidding for the specific product and (ii) an offering for auction of an additional specific product of the product type. A further step 330 involves, for each specific product of the product type, selecting a number in accordance with a predetermined formula and using that number to fix the starting price of the specific product. Accordingly, the starting price may vary in accordance with a predetermined scheme fixed by system 10. For example, system 10 may vary the starting price according to a predetermined sequence. Purely to illustrate the concept of a predetermined sequence, suppose the sequence of starting prices was 100, 99, 104, 91, 116, 75, 136, 51, 164, etc. In this particular sequence the price starts at 10 squared and then deviates in an alternating fashion below and above the initial starting price. The magnitude of the deviation is a square in the sequence of squares (e.g. 1, 4, 9, 16, 25, 36).

It should be appreciated that the predetermined formula may be designed to vary the starting prices for each specific product within the product type rather than to always have the same starting price. Accordingly, a predetermined formula that creates a number sequence 100, 100, 100, 100, 100, 100 and leads to the exact same starting price for all the specific products is not what is intended by the present invention. In an alternative version, a human operator of the on-line auction may select a number to be used to fix a starting price for each of the specific products of the product type such that the starting prices of the specific products vary.

Method 330 also includes similar remaining steps as in method 200 including a step 340 of notifying potential bidders via a communications network of the starting price for the specific product, the fixed number of bids for each specific product offered and the set time frame, a step 350 of receiving via an electronic communication medium competing bids from a plurality of bidders for the specific products, each of the bids having a bid value which exceeds values of all previously received bids a step 360 of automatically varying the quantity of specific products of the product type offered for auction by ending bidding on a specific product when the fixed number of bids has been reached within the set time frame and offering an additional specific product for auction and a step 370 of declaring a number of the competing bids having highest bid values as winning bids, the number of competing bids corresponding to the quantity of specific products of the product type auctioned, each of the winning bids enabling purchase of the specific product at the corresponding bid value.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for conducting an on-line auction of a variable quantity of specific products of a product type offered for auction, the method comprising:
fixing a set time frame in which all bidding for all specific products of the product type is to occur;
for a specific product of the product type fixing a number of bids for the first specific product sufficient to trigger (i) an end to bidding for the specific product and (ii) an offering for auction of an additional specific product of the product type;
providing, via a communications network, information pertaining to the first specific product auctioned, the information including (i) a starting price for the first specific product, the starting price selected by a random number selection process, (ii) the set time frame and (iii) the fixed number of bids;
receiving via an electronic communication medium competing bids from a plurality of bidders for the specific products, each of the bids having a bid value which exceeds values of all previously received bids;
automatically varying the quantity of specific products of the product type offered for auction by ending bidding on a specific product when the fixed number of bids has been reached within the set time frame and offering an additional specific product for auction; and
declaring a number of the competing bids having highest bid values as winning bids, the number of competing bids corresponding to the quantity of specific products of the product type auctioned, each of the winning bids enabling purchase of the specific product at the corresponding bid value.

2. The method of claim 1, further including extending the set time frame by a set amount of time whenever a new bid is placed for a specific product being offered at a time when the set time frame is about to expire.

3. The method of claim 1, further including not notifying potential bidders how many specific products of the product type are available to be offered at auction given enough bids.

4. The method of claim 1, further including notifying potential bidders how many specific products of the product type are available to be offered at auction given enough bids.

5. The method of claim 1, further including providing information pertaining to the first specific product auctioned including an acceptable bid amount.

6. A method of conducting an on-line auction of specific products of a product type in a manner that makes it likely that the winning bid amounts among the specific products will vary and that a wide range of types of buyers will bid, the method comprising:
fixing a set time frame in which all bidding for all specific products of the product type is to occur;
for a specific product of the product type fixing a number of bids for the first specific product sufficient to trigger (i) an end to bidding for the specific product and (ii) an offering for auction of an additional specific product of the product type;
for each specific product of the product type, selecting a number randomly and using that number to fix the starting price of the specific product;
notifying potential bidders via a communications network of the starting price for the specific product, the fixed number of bids for each specific product offered and the set time frame;
receiving via an electronic communication medium competing bids from a plurality of bidders for the specific products, each of the bids having a bid value which exceeds values of all previously received bids;
automatically varying the quantity of specific products of the product type offered for auction by ending bidding on a specific product when the fixed number of bids has been reached within the set time frame and offering an additional specific product for auction; and
declaring a number of the competing bids having highest bid values as winning bids, the number of competing bids corresponding to the quantity of specific products of the product type auctioned, each of the winning bids enabling purchase of the specific product at the corresponding bid value.

7. The method of claim 6, wherein each specific product has the same fixed number of bids.

8. The method of claim 6, wherein the fixed number of bids varies with each specific product.

9. The method of claim 6, wherein the fixed number of bids is selected randomly.

10. The method of claim 6, wherein the randomly selected number is the starting price.

11. The method of claim 6, further including displaying to potential bidders via the communications network a remaining number of bids needed to reach the fixed number of bids for each specific product offered.

12. The method of claim 6, further including fixing the set time frame at between ten minutes and sixty minutes.

13. The method of claim 6, further including displaying to bidders acceptable bid increments for the specific product currently auctioned.

14. A system for conducting on-line auctions of products pitched to draw bids from a wide range of buyers of the products, comprising:
(a) a database server system for receiving and storing competing bids for specific products of a product type being auctioned;
(b) user clients receiving information from the database server system concerning the specific products auctioned and sending bids to the database server system;
(c) an executable program stored in the database server system to implement the following functions:
(i) fixing a set time frame in which all bidding for all specific products of the product type is to occur;
(ii) for a specific product of the product type fixing a number of bids for the first specific product sufficient to trigger an end to bidding for the specific product and an offering for auction of an additional specific product of the product type;
(iii) for each specific product of the product type, selecting a number randomly and using that number to fix the starting price of the specific product;
(iv) receiving via an electronic communication medium competing bids from a plurality of bidders for the specific products, each of the bids having a bid value which exceeds values of all previously received bids;
(v) automatically varying the quantity of specific products of the product type offered for auction by ending bidding on a specific product when the fixed number of bids has been reached within the set time frame and offering an additional specific product for auction; and
(vi) declaring a number of the competing bids having highest bid values as winning bids, the number of competing bids corresponding to the quantity of specific products of the product type auctioned, each of the winning bids enabling purchase of the specific product at the corresponding bid value.

15. The system of claim 14, wherein the user clients have access to a display notifying potential bidders of the starting price for the specific product, a number of bids remaining from the fixed number of bids for each specific product offered remaining and the set time frame.

16. The system of claim 14, further including a display for displaying in an updateable manner to bidders time remaining in the set time frame and number of bids remaining to reach the fixed number of bids.

17. The system of claim 14, further including a display displaying a list of winning bids for specific products from the product type currently being auctioned.

18. A method of conducting an on-line auction of specific products of a product type in a manner that makes it likely that the winning bid amounts among the specific products will vary and that a wide range of types of buyers will bid, the method comprising:
fixing a set time frame in which all bidding for all specific products of the product type is to occur;
for a specific product of the product type fixing a number of bids for the first specific product sufficient to trigger (i) an end to bidding for the specific product and (ii) an offering for auction of an additional specific product of the product type;
for each specific product of the product type, selecting a number in accordance with a predetermined formula and using that number to fix the starting price of the specific product such that the starting prices of the specific products vary;
notifying potential bidders via a communications network of the starting price for the specific product, the fixed number of bids for each specific product offered and the set time frame;
receiving via an electronic communication medium competing bids from a plurality of bidders for the specific products, each of the bids having a bid value which exceeds values of all previously received bids;
automatically varying the quantity of specific products of the product type offered for auction by ending bidding on a specific product when the fixed number of bids has been reached within the set time frame and offering an additional specific product for auction; and
declaring a number of the competing bids having highest bid values as winning bids, the number of competing bids corresponding to the quantity of specific products of the product type auctioned, each of the winning bids enabling purchase of the specific product at the corresponding bid value.

19. The method of claim 18, further including selecting a number in accordance with a predetermined formula and using that number as the starting price of the specific product.

20. A method of conducting an on-line auction of specific products of a product type in a manner that makes it likely that the winning bid amounts among the specific products will vary and that a wide range of types of buyers will bid, the method comprising:
fixing a set time frame in which all bidding for all specific products of the product type is to occur;
for a specific product of the product type fixing a number of bids for the first specific product sufficient to trigger (i) an end to bidding for the specific product and (ii) an offering for auction of an additional specific product of the product type;
for each specific product of the product type, a human operator of the on-line auction selecting a number and using that number to fix the starting price of the specific product such that the starting prices of the specific products vary;
notifying potential bidders via a communications network of the starting price for the specific product, the fixed number of bids for each specific product offered and the set time frame;
receiving via an electronic communication medium competing bids from a plurality of bidders for the specific products, each of the bids having a bid value which exceeds values of all previously received bids;
automatically varying the quantity of specific products of the product type offered for auction by ending bidding on a specific product when the fixed number of bids has been reached within the set time frame and offering an additional specific product for auction; and
declaring a number of the competing bids having highest bid values as winning bids, the number of competing bids corresponding to the quantity of specific products of the product type auctioned, each of the winning bids enabling purchase of the specific product at the corresponding bid value.
